(19) United States
(12) Patent Application Publication
(10) Pub. No.: US 2021/0124154 A1
(43) Pub. Date: Apr. 29, 2021

(54) METHOD AND APPARATUS FOR OPTICAL PROJECTION

(71) Applicant: ADOK, Paris (FR)

(72) Inventors: Jimmy ROUX, Paris (FR); Paul PERETTE, Paris (FR)

(73) Assignee: ADOK, Paris (FR)

(21) Appl. No.: 16/494,518

(22) PCT Filed: Mar. 15, 2018
(86) PCT No.: PCT/EP2018/056598

§ 371 Date: Sep. 16, 2019

(30) Foreign Application Priority Data
Mar. 17, 2017 (FR) 1752229

(51) Int. Cl. G02B 13/16; G06T 3/40; G06T 7/90

(52) U.S. Cl. CPC G02B 13/16; G06T 7/90; G06T 3/403

(57) ABSTRACT

This invention concerns an optical projection apparatus, a method and a system for projection using the optical projection apparatus and at least one or more internal and/or external image data providing device. The optical projection apparatus (101) of the projection system comprises an image forming unit; and an optical unit; wherein the image forming unit produces an image to be projected by the optical unit characterized in that the image forming unit and the optical unit are configured and arranged such that an asymmetrical projection of the image with respect to the optical axis of the optical unit is obtained, wherein the projected image (105) has a width (W) and a height (H) and wherein the asymmetrical projection refers to a shift of the projected image (105) in both the directions of the width (W) and the height (H) of the projected image (105) with respect to the optical axis of the optical unit.

The present invention relates to an optical projection apparatus and the use of such an apparatus.

Such optical projectors are known. Projection type display or video projectors are positioned on a table or attached to a ceiling to display an image on a projection screen or other surfaces, like for example a wall. Traditionally, these video projection devices are used for business presentations, classroom training but also as a home theatre.

More recently, so called desktop projectors have been proposed to display an image on a surface in front of the desktop projector, e.g. on a table. Such projectors are for example described in US 2014/0362052A1, EP2 120 455 A1 or EP0982676 A1. Those desktop projectors are, however, positioned in the working space of the user, in particular in case more than one user wants to have access to the projected image.

It is therefore the object of the invention to overcome the above described drawback by providing a projector allowing a simplified and more flexible use.

The object of the invention is achieved by an optical projection apparatus comprising an image forming unit and an optical unit, wherein the image forming unit produces an image to be projected by the optical unit, characterized in that the image forming unit and the optical unit are configured and arranged such that an asymmetrical projection of the image with respect to the optical axis of the optical unit is obtained, wherein the projected image has a width and a height and wherein the asymmetrical projection refers to a shift of the projected image in both the directions of the width and the height of the projected image with respect to the optical axis of the optical unit.

The projection apparatus with asymmetrical projection allows more flexibility for the positioning of the projector relative to the projected image, as the projector can e.g. be positioned in a corner of the projected image, outside of the projected image.

The optical axis of the optical unit is defined as the line passing through the centre of curvature of the optical unit, said optical unit comprising one or more lenses and/or one or more mirrors, along which there is a rotational symmetry at least to some extent.

The image forming unit produces an image using, for instance, a light source which can comprise one or more elements resulting in the light source being monochromatic or multichromatic. A monochromatic light source could comprise filters, in particular a spinning colour wheel, and a multichromatic light source could comprise a set of light emitting devices, in particular a led or a laser, for obtaining a coloured image. An electronic system, e.g. a digital mirror device, combined to the light source can be used to form the image in a transmissive, reflective or transflective way. The optical unit of the projection apparatus can comprise a fixed part and a mobile part. The mobile part can comprise a regulation or control unit, in particular an adjustment piece and/or a zoom.

According to an embodiment of the invention, the image forming unit can be aligned with respect to the optical axis of the optical unit such that the centre of the image in the object plane of the optical unit is positioned displaced in both orthogonal directions perpendicular to the optical axis. With this relative arrangement between optical unit and image forming unit the projected image can be asymmetrically projected in two directions, with a shift along the width and height of the projected image.

In this context, the centre of the image can for instance be defined as being the intersection point of the two diagonals in case of a rectangular image.

According to an embodiment of the invention, the centre of the image in the object plane can be displaced such that the image is offset by at least 80%, preferably at least 100%, even more preferred at least 140%, in one direction. The offset value in % relates to the absolute value of displacement of the image forming unit with respect to the optical axis. In this context, a 50% offset value means the image is symmetrical with respect to the optical axis, a 100% or more offset value means the image is positioned completely outside of the optical axis.

According to another embodiment of the invention, the centre of the image can be displaced such that the image is offset by at least 100%, preferably at least 120%, in both directions. The displacement of the centre of the image in both directions enables the projector to be positioned in a corner of the projection area outside of the projected image.

According to a variation of the invention, the image forming unit can comprise a first correction unit for realizing a two dimensional keystone offset correction of the image. The keystone effect is caused by attempting to project an image onto a surface at an angle, for example with an image plane of the projector not being parallel to the screen it is projecting on. It is a distortion of the image dimensions, e.g. a rectangular gets imaged as a trapezoid. Horizontal and vertical keystone correction eliminates the trapezoid effect when the projector is placed at an angle relative to the screen position, and would result in a rectangular image display having a normal aspect ratio on the screen.

According to another variation of the invention, the image forming unit can further comprise a second correction unit for controlling a luminosity level of the image. The ability to control the luminosity level allows taking into account the imperfections of the displayed image due to its off-centered position relative to the optical axis and correcting them with a balanced luminosity, in order to maximize the overall brightness uniformity of the image.

According to an embodiment of the invention, the optical unit can be configured to realize a short focal projection with a throw ratio of less than 1:1, in particular less than 0.5:1, more in particular less than 0.4:1. A throw ratio is defined as the distance between the screen and the projector, divided by the width of the image to project. Generally, a throw ratio of less than 1:1 is considered a short throw. As an example, a short focal projection would result in a projection being 30 cm away from the projector with a width of the image of 1 m. Such short focal length would result in an image being projected close to the apparatus, so that the apparatus can, for instance, be positioned on a table.

According to a complementary feature of the invention, the optical projection apparatus can further comprise a mirror on the projection image side of the optical unit. Such mirror allows changing the direction of projection and allows reducing the throw ratio.

According to another complementary feature of the invention, the mirror can be parallel to the object plane. Using an asymmetrical projection, due to the particular alignment between the image forming unit and the optical unit according to the invention, the mirror can be positioned parallel to the object plane without that the image is reflected back into the projecting apparatus. According to an alternative the mirror can be at an angle different than 90° with respect to the optical axis. In this case an image offset in the object plane of less than 100% in both directions can be sufficient, but according to the invention the offset should at least be more than 50%.

According to an embodiment of the invention, the apparatus further can comprise a displacement means for moving the image in the image plane in one or two directions. Such displacement means allows moving the projected image by intervening on the relative positioning of the image forming unit with respect to the optical unit. Thus, the optical projection apparatus can be positioned at a suitable position with respect to the projected image.

According to an embodiment of the invention, the optical projection apparatus can further comprise a third correction unit with a colour determining means for determining the colour or colours of the projection surface and a means for adapting illumination parameters as a function of the colour or colours of the projection surface. It is then possible to use the projection apparatus on nearly any surface by adapting the projection to the texture and/or colour of the projection surface, maximizing the contrast between the projected image and the texture/colours of the projection surface. Such possibility gives more flexibility for deciding where and how to do a projection, as many surfaces could be considered for projection.

According to another embodiment of the invention, the third correction unit can comprise a camera means and a reference light source for determining the colour/s and/or texture of the projection support. Such system allows to correct the colour of the projected image so as to obtain a better contrast and colour balance, when the projection area is not simply white and exhibits colour or strong texture, such as for example wood. In the case of a composite projection support, various colour zones could be defined.

The invention also relates to a projection system for projection comprising an optical projection apparatus as described previously and at least one or more internal and/or external image data providing device/s. With this projection system the advantages of the projection apparatus can be used to project any kind of image or a plurality of images onto a surface.

According to another variation of the invention, the image data providing device of the projection system can be at least one of a computing device, a computer, a smart-phone a camera, a photo apparatus and a data storage device. The variety of image data providing devices which can be used allows for an enhanced flexibility of the projection system. For example, it can be used to view photos which were just taken with the smart-phone or view data in any environment. The system can actually also work like a computer without needing a screen. This will allow for immediate feedback or fast data analysis. The support can be a table in an office just like a conference room, but projection could take place anywhere, e.g. also while travelling in a train.

According to another variation of the invention, the projection system as described above is configured to project the image on a horizontal surface, in particular a table. The projection system can be located on the same table onto which the projection is made, which would result in a projected image being projected in front of the optical projection apparatus with a short focal length.

According to an embodiment, the optical projection apparatus can be positioned close or even on the projection area. Since the projection system requires no screen, the system can be used for small-size conference rooms or even for rooms not designed for conference or meetings. Such system allows more flexibility regarding the choice of when and where a projection can be made. No conference rooms or big rooms with screens have to be booked in advance for a meeting. A simple table in an office is enough. The area of projection could be a relatively big area, in particular of about 1 meter. Alternatively, the surface on which to project could also be vertical, such as a wall, for example for a home theatre use of the projection system. Furthermore, such system allows to simplify the setup. There is no need of external screen, mounting system, or static configurations such as ceiling mounted projectors, etc.

According to another feature of the invention, the optical projection apparatus of the projection system is positioned in a corner region external of the projection area. The projector being located not in the centre of the projection (as for home cinema) but in the corner of the projection, it allows for more flexibility and reduced projection distances. In the case of a vertical projection, for example, when a person has to stand in front of the projected image and talk, it happens often that the person enters the field of projection, due to the fact that the projector is located in the centre of the projection. The projector being located in a corner of the projection enables more freedom to move for the speaker and a reduced the risk of entering the field of projection. In the case of a horizontal projection, for example on a table, the positioning of the participants around the projected area can be improved. In this context, the corner region of the projection is defined as the region outside the projected image and between the lines intersecting at a corner of the projected image.

According to another embodiment of the invention, an optical projection method, in particular using the projection system or the optical projection apparatus described previously, comprises a step of a) providing an input image to be projected onto a surface, b) generating an image from the input image and c) projecting the corrected image onto a surface using an optical unit, characterized in that an asymmetrical projection of the image with respect to the optical axis of the optical unit is obtained wherein the projected image has a width and a height and wherein the asymmetrical projection refers to a shift of the image in both the directions of the width and the height of the projected image with respect to the optical axis of the optical unit. The inventive method allows a simpler and more flexible way to realize projections.

The invention may be understood by reference to the following description taken in conjunction with the accompanying figures, in which reference numerals identify the features of the invention.

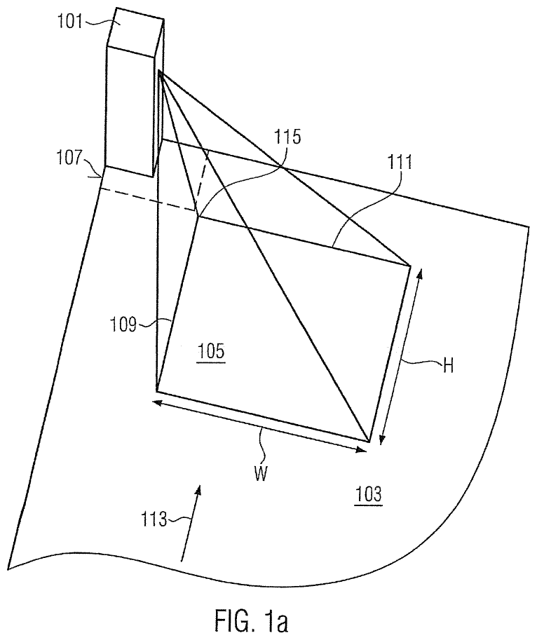

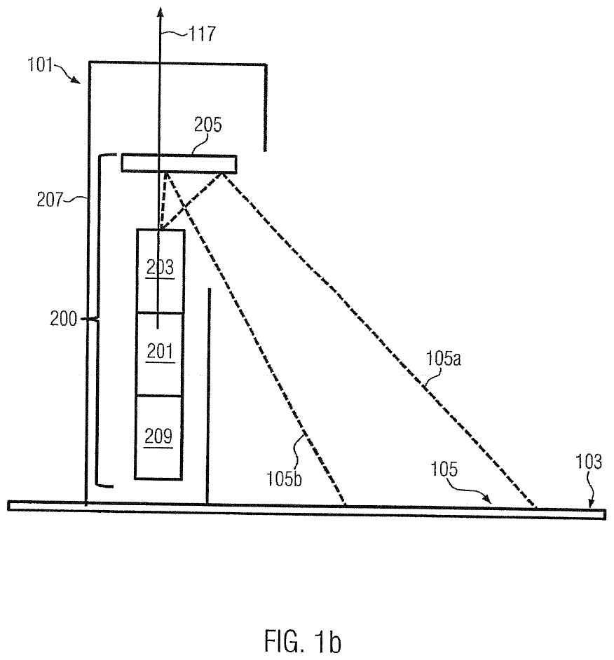

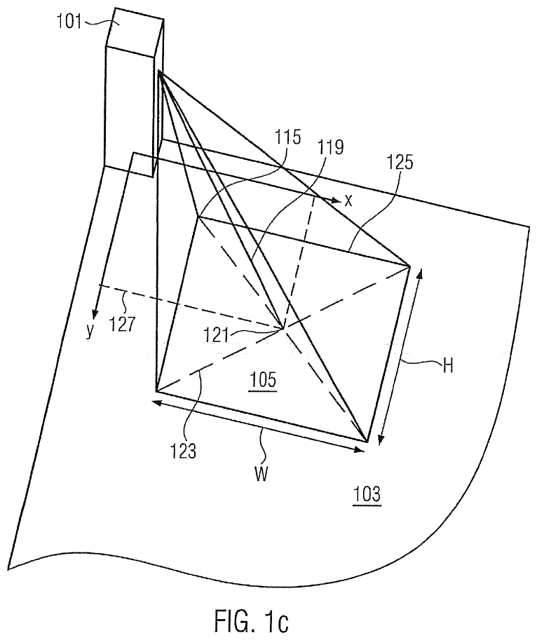

FIG. 1a shows a three dimensional schematic view of a projection system comprising an optical projection apparatus, placed in the corner of the projected area, according to the invention.

FIG. 1b shows a side view of the elements forming the optical projection apparatus used in a projection system according to the invention.

FIG. 1c illustrates the asymmetrical projection according to the invention.

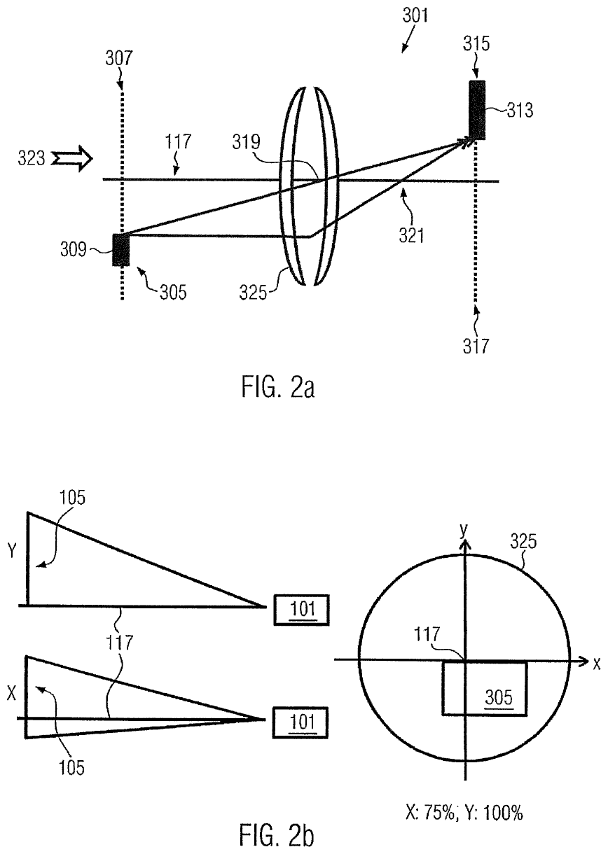

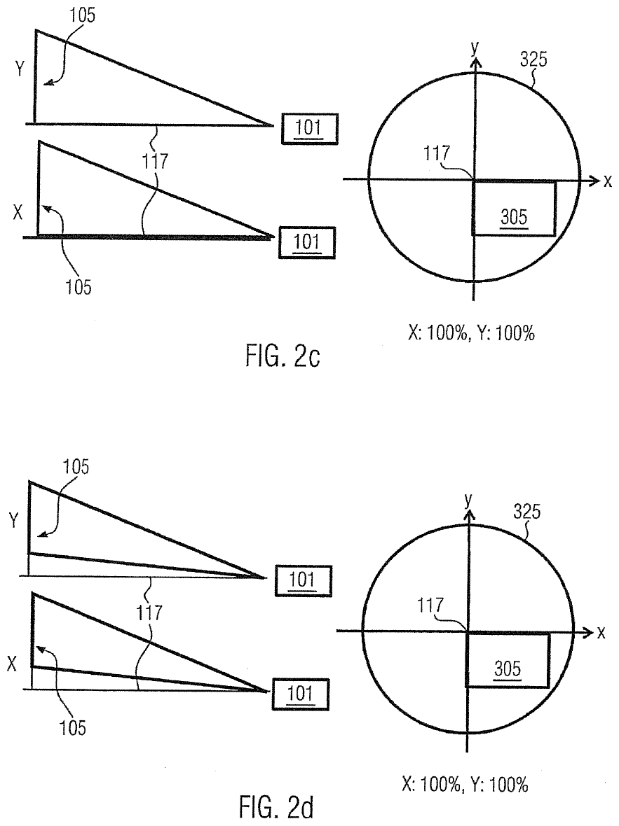

FIG. 2a shows the optical arrangement of an optical unit and an image forming unit in order to project an image with an offset in two perpendicular directions according to the invention, while FIGS. 2b, 2c and 2d show a view of the projected image in the optical plane for different offset values in two perpendicular directions.

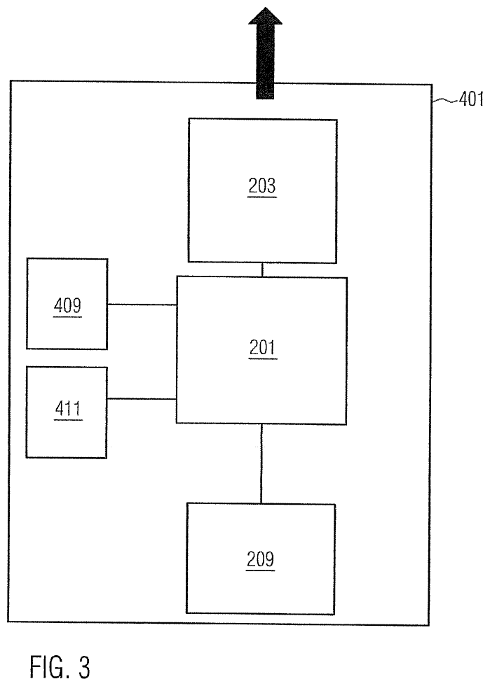

FIG. 3 shows the functional blocks of an optical projection apparatus used in a projection system according to a second embodiment.

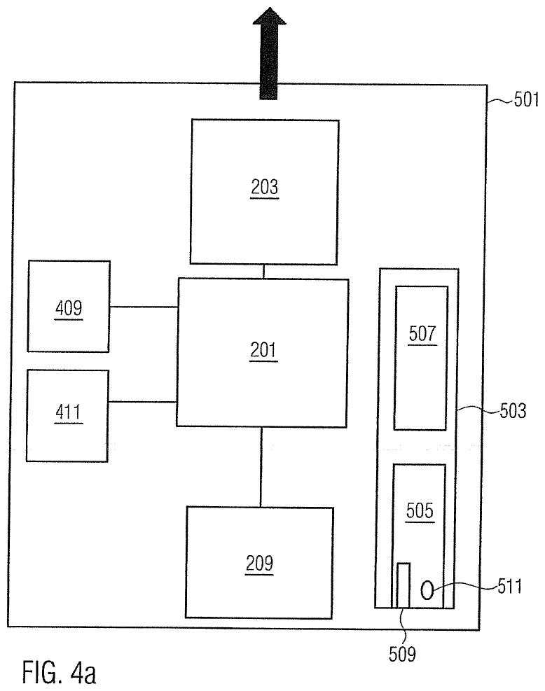

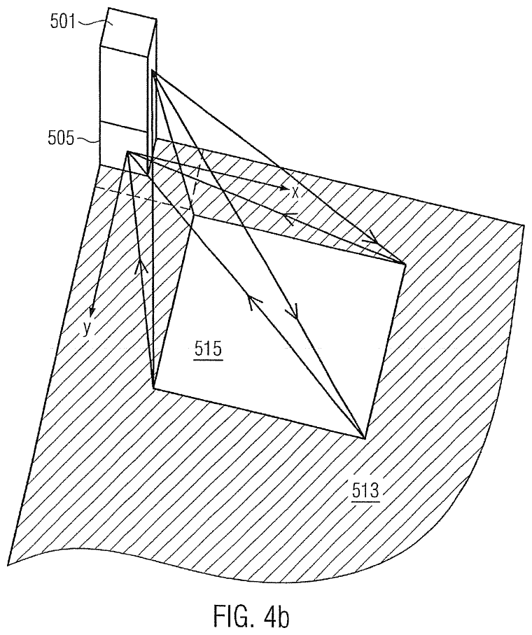

FIGS. 4a and 4b schematically illustrate a projection system according to a third embodiment of the invention wherein the optical projection apparatus comprises a colour determination means, with the functional blocks schematically illustrated in FIG. 4a and the projection system placed on a textured surface in FIG. 4b.

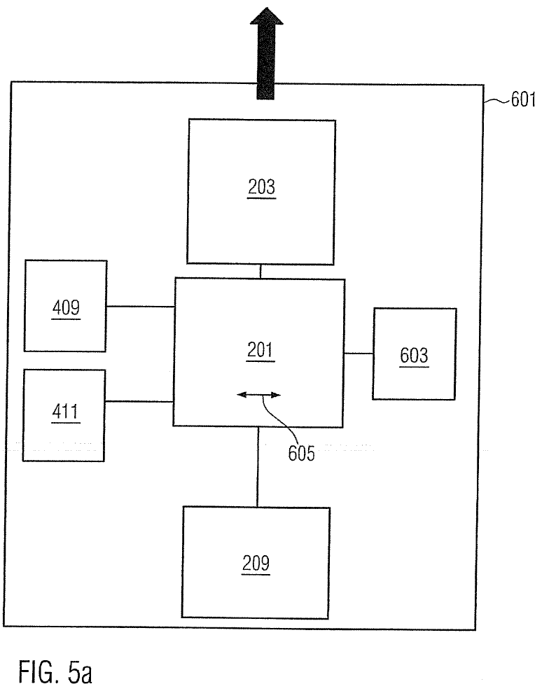

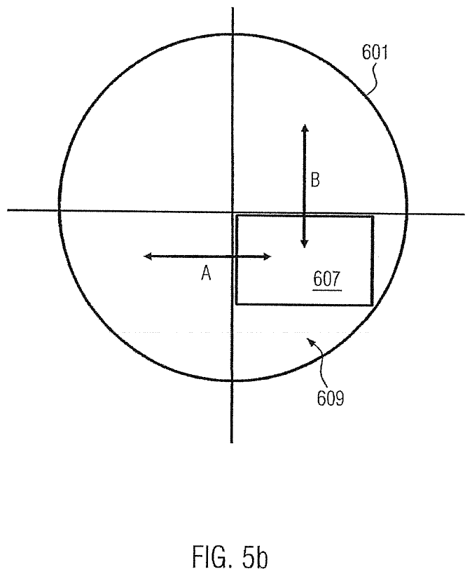

FIGS. 5a and 5b schematically illustrate a projection system according to a fourth embodiment of the invention comprising a moving element to displace the image, with the functional blocks schematically illustrated in FIG. 5a and the displacement of the projected image position shown in FIG. 5b.

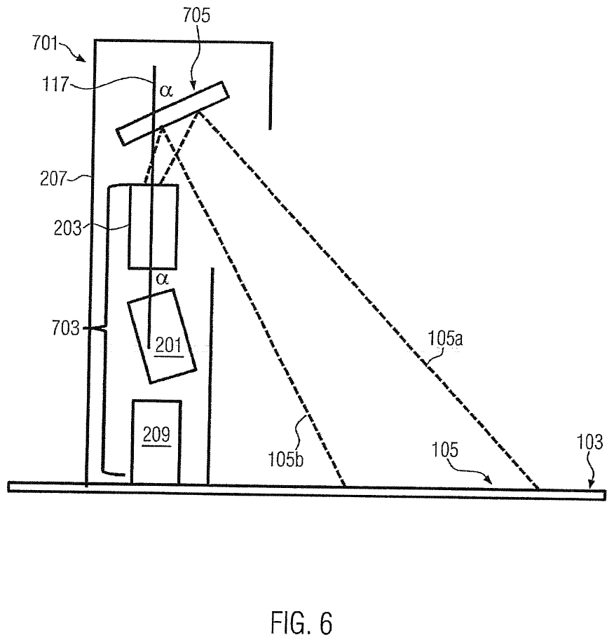

FIG. 6 schematically illustrates the elements of the optical projection apparatus of a projection system according to a fifth embodiment, with a non parallel exit mirror.

A three dimensional schematic view of a projection system 101 according to a first embodiment of the invention is shown in FIG. 1a to illustrate the gist of the invention. And FIG. 1b illustrates the side view of the elements forming the optical projection apparatus used in a projection system according to the invention.

The projection system 101 is placed on a surface 103 and projects an image 105 onto the surface 103. According to the invention, the optical projection apparatus of the projection system 101 is configured such that the projection of the projected image 105 is asymmetrical. This corresponds to a shift of the projected image 105 in the direction of the width W and the height H of the projected image 105 with respect to an optical axis 117 of an optical unit 203, shown in FIG. 1b.

The view shown in FIG. 1b is taken when looking parallel to the projection surface 103 in the direction illustrated by the arrow 113 in FIG. 1a. Elements or features carrying reference numerals already described in FIG. 1a will not be described again in detail but reference is made to their description above.

The optical projection apparatus 200 comprises an image forming unit 201, an optical unit 203 with its optical axis 117 and a mirror 205 in a housing 207. FIG. 1b shows the optical axis 117 of the optical unit 203 being mentioned in FIG. 1a. Like illustrated in FIG. 1b, the image forming unit 201 is positioned on the object plane side of the optical unit 203 and the mirror 205 is positioned on the projection image side of the optical unit 203. In this embodiment, the mirror 205 is parallel to the object plane of the optical unit 203.

In this embodiment, the image forming unit 201 comprises a light source, e.g. LEDs or lasers with or without colour wheel, and a digital mirror device (DMD) as known in the art. The image is created by small mirrors laid out in a matrix on a semiconductor chip. Each mirror represents one or more pixels in the projected image. The number of mirrors corresponds to the resolution of the projected image. An image data providing device 209 provides the image forming unit 201 with the data of the input image to be projected. The image data providing device 209 can be internal like illustrated in FIG. 1b or an external device, like for example a computing device, a computer, a smart-phone, a camera, a photo apparatus or a data storage device connected via a cable or in a wireless manner.

The optical unit 203 is build up by refractive and/or reflective elements aligned on an optical axis 117 and comprises a fixed part and a movable part to allow for focusing of the projected image 105 onto projection surface 103.

It is the alignment between the optical unit 203 and the image forming unit 201 with respect to each other that allows to offset the projected image with respect to the position of the projection system 101 both in the x and y direction. This will be explained in more detail with respect to the following Figures below.

In the embodiment illustrated in FIG. 1a, the projection system 101 is placed in a corner region 107 outside of the image 105. Here the corner region 107 is to the left of the left side 109 of the image 105 and above the upper side 111 of the image 105.

The surface 103 can be the surface of a furniture, like a table, in particular an office table or the surface of a larger table in a meeting room. According to variants, the surface 103 could also be the ground.

The optical projection apparatus of the projection system can be configured such that the projection size can be adapted to the size of the surface 103. The area of projection of the image 103 can have a diameter of up to about 1 meter or even more.

The projection system 101 can be located on the table onto which the image 105 is projected like illustrated in FIG. 1a or positioned close by.

Alternatively, the surface 103 on which to project could also be vertical, such as a wall, for example for a home theatre use or company presentations.

Thus, depending on the characteristics of the projection surface 103, the projection apparatus 101 can be configured to project downwards, e.g. on a horizontal surface, or upwards, on a vertical surface.

The projection system 101 according to the invention comprises an optical unit which is configured to realize a short focal projection with a throw ratio of less than 1:1, in particular less than 0.5:1, more in particular less than 0.4:1. The throw ratio is defined as the D/W between the distance D between the light leaving position at the projection system 101 and the projection surface 103 and the width W of the image.

FIG. 1c illustrates the asymmetrical projection according to the invention in more detail. Elements carrying the same reference numerals as in FIG. 1a, are not described in detail again but reference is made thereto.

In FIG. 1c the projection system 101 projects image 105 onto surface 103 like in FIG. 1a. FIG. 1c illustrates a referential with the x axis running parallel to the width W direction of the projected image 105 and the y axis running parallel to the height H direction of the projected image. The X and Y axis intersect at the optical axis 117 of the optical unit 203 of the projection system 101. The projection axis 129 of the projection system 101 is also shown.

FIG. 1c also illustrates the center 121 of the projected image 105 which is defined as the intersection of the two diagonals 123 and 125 of the projected image 105.

Now, according to the invention, the center 121 of projected image 105 is shifted both in the direction x (along the width W) and in the direction y (along the height H) to realize the asymmetrical projection. In the x direction, the shift with respect to the optical axis 117 carries the reference numeral 127, whereas in the y direction, the shift with respect to the optical axis 117 carries the reference numeral 129.

FIG. 2a schematically illustrates the position of the image to be projected with respect to the optical axis 117 of the optical unit 203 in the projection system 101 as illustrated in FIGS. 1a and 1c such that it is projected asymmetrically with respect to the optical axis 117 of the optical unit 203.

FIGS. 2b, 2c and 2d show a view of the projected image 305 in the optical plane for different offset values in two perpendicular directions. FIG. 2b shows the projected image in the optical plane with an offset of 50% in the one direction and 100% in the other direction not according to the invention, FIG. 2c shows the projected image in the optical plane with an offset of 100% in both directions and FIG. 2d shows the projected image in the optical plane with an offset superior to 100% in both directions. Elements or features carrying reference numerals already described in FIG. 1a/b or c will not be described again in detail but reference is made to their description above.

FIG. 2a shows a schematic side view of the optical arrangement 301 of the optical unit 203 and of the image formed by the DMD of the forming unit 201 in order to project an image with an offset. For ease of understanding the schematic view does not represent the mirror 205 as shown in FIG. 1b. The image 305 created on the DMD of the optical forming unit 201 is positioned in the object plane 307 of the optical unit 203 with its centre 309 positioned away from the optical axis 117 of the optical unit 203 such that the centre 313 of the projected image 315 in the projection plane 317 of the optical unit 203 is offset with respect to the optical axis 117. FIG. 2a also schematically illustrates the light propagation through the optical unit 203 via the optical centre 319 of the optical unit 203 and the focal point 321 on the projection side of the optical unit 203.

As illustrated, the optical unit 203 can comprise one or more lenses and/or one or more spherical mirrors or prisms or a combination thereof.

FIG. 2b shows on the right side a view of the image 305 formed by the image forming unit 201 onto the entrance optics 325 (see FIG. 2a) of the optical unit 203. This view is taken when looking parallel to the optical axis 117 in the direction illustrated by the arrow 323 in FIG. 2a. The left side of FIG. 2b illustrates the projection system 101 with the projected image 105 along the x and y axis as illustrated in FIG. 1a relative to the optical axis 117 of the optical unit 203.

As mentioned on the FIG. 2b, the image 305 is offset by 75% in the X direction and 100% in the y direction, with the value of 50% representing a situation in which the image 305 would by symmetrical with respect to the x and/or y axis. Thus, according to the invention an asymmetrical projection with the centre of the image being offset with respect to the optical axis 117 can be obtained for both directions when aligning the image forming unit 201 such that the image formed enters the optical unit 203 such that an offset of more than 50% is observed in both directions x and y.

This is illustrated in the left part of the FIG. 2b showing that along the Y axis the projected image 105 is completely positioned to the one side of the optical axis 117, whereas along the X axis 25% of the projected image 105 are on the one side of the optical axis 117 and 75% of the projected image are on the other side of the optical axis 117.

FIG. 2c shows on the right side an alignment of the image forming unit 201 with respect to the optical unit 203 where the image 305 on the entrance optics 325 is offset by 100% both in the x and the y direction. Again, this view is taken when looking parallel to the optical axis 117 in the direction illustrated by the arrow 323 in FIG. 2a.

A 100% value means the projected image 105 is completely to one side of the optical axis 117 as illustrated on the left side of FIG. 2c. The X: 100%, Y: 100% situation corresponds to a positioning of the projection system 101 so that the optical axis 117 coincides with the intersecting point 115 of the image delimiting lines 109 and 111 shown in FIG. 1a.

According to further embodiments of the invention, the image forming unit 201 and the optical unit 203 can be positioned such that the centre of the image 105 can be displaced more than 100%, preferably at least 120%, in both directions x and y. This situation is illustrated in FIG. 3d. Again, this view is taken when looking parallel to the optical axis 117 in the direction illustrated by the arrow 323 in FIG. 2a. In FIG. 1a, the projection apparatus is positioned further away from intersecting point 115 in the corner region 107 corresponding approximately to an offset of about 120% in both the x and y direction.

Offset values of more than 100% in both directions are interesting as the mirror 205 can be used on the projection side of the optical unit to redirect the image without that part of the image is reflected back into the projection system.

FIG. 3 schematically illustrates the functional blocks of a projection system 401 according to a second embodiment of the invention. Elements or features carrying reference numerals already described with respect to any one of FIGS. 1 and 2 will not be described again in detail but reference is made to their description above.

Like in the first embodiment, the projection system 401 of the second embodiment comprises an input image device unit 209 that provides the image forming unit 201 with the data of an input image. The light source and the DMD of the image forming unit 201 then produce an image from the data.

According to the second embodiment, the image data is corrected to take into account image distortions and/or to enable a more even luminosity. Thereto, the projection system 401 comprises a first correction unit 409 and/or a second correction unit 411. The first correction unit 409 is configured to realize a two dimensional keystone offset correction to take into account image distortions.

The second correction unit 411 is configured to control the luminosity level of the produced image. To be able to realize an asymmetrical projection, the off-centre regions of the optical unit is illuminated which leads to different luminosity levels in the projected image. This unwanted effect is compensated by the second correction unit. The corrected image is then projected through the optical unit 203.

FIGS. 4a and 4b schematically illustrate a projection system according to a third embodiment of the invention wherein the optical projection apparatus comprises a colour determination means.

The functional blocks schematically are illustrated in FIG. 4a and the projection system of the third embodiment placed on a textured surface is illustrated in FIG. 4b. Elements or features carrying reference numerals already described with respect to any one of FIGS. 1a/c to 3 will not be described again in detail but reference is made to their description above. The features of the first and/or second embodiment can be combined with the features of the third embodiment.

FIG. 4a shows the functional blocks of the projection system 501 of the third embodiment comprising a third correction unit 503 allowing a colour detection or texture determination of the surface onto which the image will be projected and an adaption of the illumination to correct the image data as a function of the colour and/or texture.

The third correction unit 503 comprises a colour determining means 505 for determining the colour or colours of the projection surface and an adapting means 507 for adapting illumination parameters as a function of the colour or colours of the projection surface.

According to one variant, the colour determining means 505 can comprise a camera means 509 and a reference light source 511 for determining the colour of the projection support. It is then possible to adapt the projection of the image to the texture and/or colour of the projection surface, thereby improving the contrast between the projected image and the texture/colours of the projection surface. The third correction unit 503 thus corrects the image according to the colour and/or texture of the projection image in the image forming unit 201 before the optical unit 203 projects the image.

FIG. 4b shows the projection system 501 positioned on a textured surface 513, e.g. a wooden table, with a colour different than white. Before projecting an image 515, the camera means 509 of the third correction unit 503 analyses the projection surface using the light emitted by the reference light source 511. Based on the results obtained, the adapting means 507 calculates correction parameters to be applied to the image data, so that the colour and texture of the projection surface 513 can be taken into account when preparing the image to be projected. Thus it becomes possible to use nearly any surface as projections surface with satisfying contrast and luminosity.

FIGS. 5a and 5b schematically illustrate a projection system 601 according to a fourth embodiment of the invention comprising a moving element 603 to displace the image, with the functional blocks schematically illustrated in FIG. 6a and the displacement of the projected image position shown in FIG. 5b. Elements or features carrying reference numerals already described with respect to any one of FIGS. 1a/c to 4 will not be described again in detail but reference is made to their description above. The embodiment illustrated in FIGS. 5a and 5b is a variant of the second embodiment illustrated in FIG. 3a, but the features of any one of the first to third embodiment can be combined with the additional features of the fourth embodiment.

The projection system 601 according to the fourth embodiment comprises a displacement means 603 in addition to the elements of the projection system 401 of the second embodiment. The displacement means 603 can move the image forming unit 201 with respect to the optical unit 203 in one or two directions (illustrated by arrow 605) relative to the optical axis, such that the image produced by the optical unit 203 also moves on the projection image side of the optical unit 203.

FIG. 5b shows the displacement of the image created by the imaging forming unit 201 on the optical unit 203 in the projection system 601 according to the fourth embodiment of the invention. The image 607 is shown in the entrance plane 609 of the optical unit 203. The displacement unit, e.g. a stepper motor, can move the image forming unit 201 such that the image 607 moves along the direction of the axis A and/or the axis B of the optical unit 203. As a consequence the projected image can be moved along axis X and Y (see FIG. 1a).

FIG. 6 schematically illustrates the elements of a projection system 701 according to a fifth embodiment, with an optical projection apparatus 703 and an exit mirror 705 that is no longer parallel to the object plane of the optical unit 203. Elements or features carrying reference numerals already described with respect to any one of FIGS. 1a/c to 5 will not be described again in detail but reference is made to their description above. Features of any one of the first to fourth embodiment can be combined with the additional features of the fifth embodiment.

Furthermore, as schematically illustrated the image forming unit 201, more precisely the image created by the digital mirror device of the unit 201 is no longer parallel to the object plane. Preferably the DMD and the mirror 705 have the same angle α with respect to the optical axis 117.

With a mirror 705 at an angle α relative to the projection plane, the offset of the image 309 onto the entrance optics 325 can be less than 100%, in particular 75% in one or in two directions without that the image reflected by the mirror 705 can re-enter the optical unit 203.

In this embodiment the correction unit realizing the keystone correction has to be adapted to the new geometry.

A number of embodiments of the invention have been described. Nevertheless, it is understood that various modifications and enhancements may be made without departing the following claims

1. An optical projection apparatus comprising:
an image forming unit (201); and
an optical unit (203);
wherein the image forming unit (201) produces an image to be projected by the optical unit (203);
the image forming unit (201) and the optical unit (203) are configured and arranged such that an asymmetrical projection of the image with respect to the optical axis (117) of the optical unit (203) is obtained, wherein the projected image has a width and a height and wherein the asymmetrical projection refers to a shift of the projected image in both the directions of the width and the height of the projected image with respect to the optical axis (117) of the optical unit (203).

2. The optical projection apparatus according to claim 1, wherein the image forming unit (201) is aligned with respect to the optical axis (117) of the optical unit (203) such that the center (121) of the image in the object plane of the optical unit (203) is positioned displaced in both orthogonal directions perpendicular to the optical axis (117) of the optical unit.

3. The optical projection apparatus according to claim 2, wherein the center (121) of the image is displaced such that the image is offset by at least 80%, in one direction.

4. The optical projection apparatus according to claim 2, wherein the center (121) of the image is displaced such that the image is offset by at least 100% in both directions.

5. The optical projection apparatus according to claim 1, wherein the image forming unit (201) comprises a first correction unit (409) for realizing a two dimensional keystone offset correction of the image.

6. The optical projection apparatus according to claim 1, wherein the image forming unit (201) further comprises a second correction unit (411) for controlling a luminosity level of the image.

7. The optical projection apparatus according to claim 1, wherein the optical unit (203) is configured to realize a short focal projection with a throw ratio of less than 1:1.

8. The optical projection apparatus according to claim 1, further comprising a mirror (205) on the projection image side of the optical unit (203).

9. The optical projection apparatus according to claim 8, wherein the mirror (205) is parallel to the object plane.

10. The optical projection apparatus according to claim 1, further comprising a moving element (603) that moves the image in the image plane in one or two directions.

11. The optical projection apparatus according to claim 1, wherein the image forming unit (201) further comprises a third correction unit (503) with a color determining means (505) for determining the color or colors and/or texture of the projection surface and an adapting means (507) for adapting illumination parameters as a function of the color or colors of the projection surface.

12. The optical projection apparatus according to claim 11, wherein the third correction unit (503) comprises a camera (509) and a reference light source (511) for determining the color and/or texture of the projection support.

13. A projection system for projection, comprising
an optical projection apparatus according to claim 1;
and at least one or more internal and/or external image data providing device (209).

14. The projection system for projection according to claim 13, wherein the image data providing device (209) is at least one of a computing device, a computer, a smart-phone, a camera, a photo apparatus or a data storage device.

15. The projection system according to claim 13, configured to project the image on a horizontal surface.

16. The projection system according to claim 13, wherein the optical projection apparatus is positioned in a corner region external of the projection area.

17. An optical projection method, using the projection system according to claim 13, said method comprising:
a) providing an input image to be projected onto a surface;
b) generating an image from the input image;
c) projecting the corrected image onto a surface using an optical unit (203);
wherein an asymmetrical projection of the projected image with respect to the optical axis (117) of the optical (203) unit is obtained wherein the projected image has a width and a height and wherein the asymmetrical projection refers to a shift of the image in both the directions of the width and the height of the projected image with respect to the optical axis (1 17) of the optical unit (203).
